(19) United States
(12) Patent Application Publication
(10) Pub. No.: US 2014/0032352 A1
(43) Pub. Date: Jan. 30, 2014

(54) Systems and Methods for Live Auctioneer Led Sales

(71) Applicant: MANHEIM INVESTMENTS, INC., Atlanta, GA (US)

(72) Inventors: Alexander Harley Fraser, Statesville, NC (US); John Blobner, Johns Creek, GA (US); Lance Rigdon, Smyrna, GA (US); Krista Gayle Wright, Atlanta, GA (US); Veronica Yung Su Tai, Atlanta, GA (US); Richard Neil MacConnell, Norcross, GA (US); Amy Andrews Mills, Atlanta, GA (US)

(73) Assignee: MANHEIM INVESTMENTS, INC., Atlanta, GA (US)

(21) Appl. No.: 13/835,430

(22) Filed: Mar. 15, 2013

Related U.S. Application Data
(63) Continuation-in-part of application No. 13/559,315, filed on Jul. 26, 2012.

(51) Int. Cl. G06Q 30/08

(52) U.S. Cl. CPC G06Q 30/08
USPC 705/26.3

(57) ABSTRACT

Systems and methods for providing live auctioneer led sales of products, such as vehicles, between remotely located buyers, sellers, and auctioneers are provided herein. In certain aspects, systems and methods may facilitate one or more auctions led by a remotely located live auctioneer who receives bids from one or more remotely located buyers. Accordingly, in some examples, the auctioneer may accept bids from the buyers, encourage bidding from the buyers, and/or declare (or not declare) a product sold in real-time. In this manner, in certain aspects, the systems and methods enable an auction to be conduct by a live auctioneer.

### CROSS REFERENCE TO RELATED APPLICATIONS

This application is a continuation-in-part of and claims the benefit of and priority to U.S. patent application Ser. No. 13/559,315, entitled “Systems and Methods for Live Auctioneer Led Sales,” filed on Jul. 26, 2012, which is hereby incorporated by reference in its entirety.

### BACKGROUND

Vehicles are often sold at live auctions and online auctions. An advantage of a live auction is that it tends to ensure price realization, i.e., a price that adequately reflects the market value of the vehicles being sold. However, live auctions typically happen at a certain location—typically an auction house, stockyard, or estate. Participants, such as buyers, sellers, and auctioneers, as well as the items to be sold, must travel to the site of the auction which may present logistical challenges, including travel and transportation costs, which may be significant.

### BRIEF DESCRIPTION OF THE DRAWINGS

The detailed description is set forth with reference to the accompanying drawings, which are not necessarily drawn to scale. In the figures, the left-most digit(s) of a reference number identifies the figure in which the reference number first appears. The same reference numbers in different figures indicate similar or identical items.

FIG. 1 is a block diagram of an illustrative system, according to an embodiment of the disclosure.

FIG. 2 is a flow diagram illustrating details of a method, according to an embodiment of the disclosure.

FIG. 3 is a flow diagram illustrating details of a method, according to an embodiment of the disclosure.

### DETAILED DESCRIPTION

### Overview

Illustrative embodiments will now be described more fully hereinafter with reference to the accompanying drawings, in which some, but not all embodiments are shown. The disclosure may be embodied in many different forms and should not be construed as limited to the embodiments set forth herein; rather, these embodiments are provided so that this disclosure will satisfy applicable legal requirements. Like numbers refer to like elements throughout.

Illustrative embodiments may generally be directed to, among other things, providing live auctioneer led sales of vehicles between remotely located buyers, sellers, and auctioneers. In certain aspects, the vehicles may be sold through an auction platform, such as, for example, a server-based platform wherein each seller, buyer, and/or auctioneer may access the platform. In this manner, the platform may facilitate one or more auctions led (or driven) by a remotely located live auctioneer that may receive bids over the platform from one or more remotely located buyers. Accordingly, in some examples, the auctioneer may accept bids from the buyers, encourage bidding from the buyers, and/or declare (or not declare) a vehicle sold in real-time. In this manner, in certain aspects, the platform enables an auction to be conducted by a live auctioneer as if the auctioneer, the buyers, and the sellers were in the same physical location—like a traditional auction. The use of a live auctioneer in real-time communication with the buyers over the platform tends to ensure price realization (i.e., a price that adequately reflects the market value) of the vehicles being sold.

In certain aspects, one or more sellers may designate vehicles to be auctioned through the platform via an auction-style sale. In some instances, the sellers may also provide information associated with the vehicles to be purchased through the platform, including, but not limited to, a vehicle identification number (VIN), a make, a model, a year, a condition, a color, a trim, a value, a mileage, an image, a recording, a video, a location, seller information, an inventory identifier, a rating, a review, an amount of time the vehicle has been in a particular inventory, an amount of time the vehicle has been available for exchange, trade, or sale, or a vehicle history. In other instances, the information associated with the vehicles may be determined and/or received from one or more third parties, including, but not limited to, one or more vehicle identification number decoders, inventory management systems, dealer management systems, original equipment manufacturer databases, distributor databases, market value databases, vehicle history databases, or the like. In yet other instances, the information associated with the vehicles may be partially provided by the sellers and/or partially provided by the third parties.

Additionally, in some aspects, the sellers may provide information associated with a number of vehicles in the sellers' inventory. In certain instances, the sellers may filter the vehicle inventory based on the information associated with the vehicles. In this manner, the sellers may filter the vehicle inventory to view a specific subset of the vehicle inventory. For example, the sellers may filter the vehicle inventory based on at least a portion of a vehicle identification number (VIN) because certain digits of the VIN are indicative of the make, the model, or the place of manufacture, etc. of the vehicle. Moreover, the sellers may filter the vehicle inventory based on one or more of: a make, a model, a year, a condition, a color, a trim, a value, a mileage, a location, an inventory identifier, a rating, a review, an amount of time the vehicle has been in a particular inventory, an auction parameter, or an amount of time the vehicle has been available for exchange, trade, or sale, a combination thereof, or the like. Further, the sellers may designate one or more vehicles in the vehicle inventory (or a filtered subset thereof) to be sold via an auction through the platform. In this manner, the sellers may designate a run order (i.e., the order that the vehicles are to be auctioned off). In some instances, the sellers may designate a specific auction to sell the vehicles. For example, several auctions may be scheduled for a day, a week, a month, or a year, etc. Moreover, some auctions may be identified by the location of the sellers, the buyers, and/or the vehicles to be auctioned. In both instances, the sellers may specify which auction or auctions each of their vehicles may be sold.

In one example embodiment, the platform may facilitate an auction led by a remotely located live auctioneer. For example, the sellers, the buyers, and the auctioneer (and in some instances a block clerk that assists the auctioneer in conducting the auctions) may all be remotely located from one another. That is, they may all be located in geographically remote location, such as, for example, in different structures, cities, counties, states, countries etc. Any distance is within the scope of this disclosure. In certain aspects, the auctioneer may lead, control, drive, manage, or the like an auction via the platform. That is, in some examples, the auctioneer may take bids and/or encourage bidding from the buyers over the platform in real-time. For example, in certain embodiments, the buyers and/or the sellers may be provided with a real-time audio signal, video signal, or combination thereof of the live auctioneer conducting the sale of the vehicles by auction. Other signals associated with the live auctioneer may also be provided to the buyers and/or sellers. Similarly, the auctioneer may be provided with a real-time indication of one or more bids being placed by the buyers via the platform for the vehicles for sale by auction. For example, the indication of a bid from the buyers may include, but is not limited to, an audio signal, a video signal, an email, a text message, an instant message, a voice message, a video message, a telephone call, a video call, a combination thereof, or the like. In one example embodiment, the buyers may select (e.g., by clicking or hitting) a virtual button that may place a bid at the next incremental amount.

In some aspects, the platform may be configured to enable the live auctioneer to change and/or adjust the bid increment dynamically during an auction. For example, if a vehicle has a floor price of $35,000, the live auctioneer may start the bidding off at $28,000 with a bid increment of $500. In this manner, at the start of the auction, the virtual button may increase the bid by $500 when selected by the buyers. However, as the bidding gets closer to $35,000, the live auctioneer may change the bid increment to $250, for example, to spur additional bidding. In doing so, the virtual button may increase the bid by $250 when selected by the buyers. The live auctioneer may change the bid increment to any amount for any reason at any time.

In some instances, the platform may be configured to enable the buyers to initiate (or start) the bidding process. For example, the buyers may submit an initial bid amount that is greater to or less than the starting bid. In other instances, the platform may be configured to allow the buyers to increase or “jump” the bid increment. That is, the buyers may increase the bid by an amount greater than the bid increment by submitting said increased amount. In either event, the bidder may be able to enter the bid using a textual field, or the like, such that the system receives a bid of more than the floor or the next incremental amount.

In other instances, the platform may include a logistics system configured to inform and/or notify the buyers at the time of bidding (or thereafter) on when they can expect to receive a vehicle purchased at auction. This logistics system could integrate with third party system(s) to provide optimized delivery estimates. Moreover, in some embodiments, the buyers may be updated by way of a text, email, phone call or the like if the expected delivery date or time changes.

In some aspects, the platform may include a “virtual ringman.” That is, during the bidding process, the buyers may be presented with information to encourage bidding. For example, the virtual ringman may comprise a pop up window or a float-over element, such as, e.g., an image or silhouette of a ringman. A ringman is someone who roams the auction floor of a traditional auction working in tandem with the auctioneer to encourage bidding from the buyers. In this manner, the virtual ringman may identify features of interest associated with the vehicle up for auction and provide the information to the buyers. The virtual ringman may be customized to each buyer. That is, depending on the location of the buyer and/or seller, the type of vehicle being auctioned, the current bid, past purchases, bidding patterns, etc., the virtual ringman may present different information to different buyers and/or interact differently with different buyers. Moreover, the live auctioneer may be provided with information associated with the buyers. For example, during each auction, the live auctioneer may have access to buyer information, such as location, OEM affiliation, past purchases, bidding and/or buying patterns, etc. In this manner, the live auctioneer can make a personal connection with the buyers bidding on the vehicles.

In certain embodiments, the platform may be configured to identify a winning bid for the vehicle. For example, in some instances, the platform may determine a winning bid for the vehicle and/or the auctioneer (or an assistant, such as the block clerk) may determine a winning bid for the vehicle. In such instances, the auctioneer or the block clerk may then enter the winning bid into the platform so that the seller may be notified of the winning bid. Moreover, in certain aspects, information associated with the winning bid and the winning buyer may be forwarded to the seller so that the seller and the buyer may complete the transaction. In certain embodiments, the platform may be configured to enable the live auctioneer to select which bidder (i.e., buyer) to sell the vehicle to once the live auctioneer has made the last call for bids. This feature may eliminate and/or reduce the ability of a buyer to “snipe” listings by waiting until the very last second and clicking the virtual bid button. Otherwise, a scenario may occur where the live auctioneer might verbally announce that bidding was over and indicate who the winning buyer was only to have another buyer enter a bid thereafter and actually win the auction. This feature prevents the aforementioned scenario. For example, in some instances, at the end of bidding, the live auctioneer may announce last call and a window or the like may be presented to the live auctioneer showing the most recent bids. The live auctioneer then has the option of selecting one of the most recent bids and selling the car to that buyer or dismissing last call and allowing bidding to continue.

In certain embodiments, the buyers may be presented with a listing of one or more vehicles to be sold by auction. In some instances, the listing of vehicles may include the above described information associated with the vehicles. In addition, in other instances, the listing of vehicles may be sorted or filtered by the buyer. For example, the buyer may sort the listing of vehicles by one or more of: at least a portion of a vehicle identification number (VIN), a make, a model, a year, a condition, a color, a trim, a value, a mileage, a location, a seller, an inventory identifier, a rating, a review, an amount of time the vehicle has been in a particular inventory, an auction parameter (such as reserve price, starting bid, floor, etc.), an amount of time the vehicle has been available for exchange, trade, or sale, an order that the vehicles will be auctioned, a buyer preference, a combination thereof, or the like. As such, the buyers may filter the listing of vehicles to determine one or more vehicles to bid on during an auction. In other embodiments, the buyers may be presented with a listing of auctions and/or sellers. In addition, in some examples, the listing of auctions or sellers may be sorted or filtered by the buyer. For example, the buyer may filter the auctions and/or sellers by location, date, time, auction inventory, etc. In this manner, the buyer may identify a particular auction and/or seller to purchase vehicles from. It is appreciated that any parameter may be used to filter the above described listings.

In some aspects, the platform may facilitate communication between the buyers and the sellers before, during, and after the sale of a vehicle. That is, in some examples, the platform may include an interface that facilitates sending an email, a text message, an instant message, a voice message, a video message, a telephone call, a video call, or the like between a buyer and a seller. Alternatively or additionally, the platform may enable information from buyers, sellers or platform administrators to be posted directly to pages, such as vehicle pages or auction pages, directly on the platform. Moreover, the platform may be configured to provide an indication to the buyer of various services provided by the seller, such as, but not limited to, reconditioning services and the associated costs. Additionally, in some embodiments, buyers, sellers, and/or other users of the platform may provide reviews and/or ratings of users (including the buyers and sellers) using the platform and/or reviews and/or ratings of vehicles purchased through the platform.

In some instances, the platform may be configured to enable the buyers to identify vehicles of interest. In certain embodiments, if a buyer identifies a vehicle of interest, the platform may be configured to notify the buyer when the vehicle is up for auction. For example, the platform may include functionality to estimate the time a vehicle will cross the auction block. In this manner, the platform may provide the buyer with a notification, such as a text message, pop-up-screen, email, phone call, etc., alerting the potential buyer that the vehicle they are interested in is about to cross the auction block. In other embodiments, the platform may be configured to enable the buyers to identify vehicles in a seller's inventory and request that the identified vehicles be offered for sale in an upcoming auction. For example, the platform may enable the buyers to select or indicate an interest in one or more vehicles in the seller's inventory (or among the vehicles that the seller has consigned for auction or set for wholesale disposition), and the platform and/or seller may add those vehicles to an upcoming auction, such as the next scheduled auction. In some instances, the buyers may be notified when the identified vehicles are placed in the next auction.

In certain embodiments, the sellers may designate a reserve price for the vehicle. In some instances, the platform may be configured to determine if a bid for the vehicle is greater than or equal to the reserve price for the vehicle. Additionally, in other embodiments, the sellers may indicate a no-sale for the vehicle. That is, if a vehicle for auction is not receiving many bids (if any) and the reserve price is not likely to be met, the seller may have the option to designate the sale a no-sale, which may end the auction immediately. Further, the platform may be configured to enable sellers to designate dynamic pricing for groups of vehicles. That is, in some instances, the sellers may enter a total sale price for the group of vehicles. As each of the vehicles in the group sell, the platform may automatically adjust the sales pricing of the remaining vehicles. In other instances, as each of the vehicles in the group sell, the platform may inform the seller of the total sale price, thereby allowing the seller to adjust the pricing of the remaining vehicles. For example, the reserve price for a vehicle may be lowered if other vehicles are selling for a greater amount than expected. Conversely, the reserve price for a vehicle may be raised if other vehicles in the group are selling for less than expected.

In certain embodiments, the buyers may place proxy bids (also known as absentee bids or automatic bids). That is, the buyers may designate a maximum amount they are willing to bid for a vehicle. In such instances, as other bids are made, the platform may automatically increase the bids by a pre-specified increment until the maximum amount is reached. Alternatively, proxy bids may be entered in other than predetermined increments, and so long as a maximum proxy bid is not exceeded, a proxy bidder's bid may be increased to match or exceed the other bidder's bid. Moreover, in some instances, the buyers may place if/then proxy bids. In such instances, a buyer may identify one or more vehicles that the buyer wants to bid on in the alternative. That is, if the buyer wins an auction on a first vehicle, the buyer may only want to bid a certain amount for a subsequent vehicle in a subsequent auction or the same auction. Alternatively, if the buyer wins an auction on a first vehicle, the buyer may not want to bid on a subsequent vehicle in the same auction or a subsequent auction.

In some instances, the buyers can add one or more vehicles from their own inventories to a future auction event. For example, the platform may have access to the buyer's inventory information and/or the buyer may provide said information. In this manner, the buyer may add vehicles to auctions (thereby becoming sellers). That is, in some instances, a user of the platform may be a seller, while in other instances the same user may be a buyer. For example, a user may buy a car in one auction and sell the same car in another auction.

In some examples, the platform may provide settlement services such as, but not limited to, return services, title services, shipping services, arbitration services, financing services, payment transfer services, and the like, to the buyers and sellers once a sale occurs. Additionally, the platform may provide functionality for completing the sale. However, in some examples, the platform may only facilitate communication between the buyers and sellers and may not actually be involved in the settlement of the transaction between the buyers and sellers. Further, in some examples, sellers may be owners who wish to sell or exchange their vehicles, or those with the authority to sell or exchange the vehicle for the owners. Additionally, buyers may be those people or entities that receive vehicles, new or used, in exchange for either money (or its equivalent) or other items. Generally, but not always, the buyer may intend, or attempt, to resell the vehicle that was purchased.

In some aspects, the platform may determine or identify wholesale, retail, and/or other values for vehicles in the platform. In other examples, a wholesale and/or retail value may be provided by the seller, a dealer management system (DMS) service, a third-party vehicle valuation service, a combination thereof, or the like. For example, the value may be based on the condition of the vehicle, the mileage, the year, the make and/or the model of the vehicle, and/or market conditions, such as real-time market conditions, related to the same or similar vehicles.

In certain embodiments, the platform may provide a dynamic, no-questions-asked, money-back, vehicle-return guarantee for vehicle purchases. In some aspects, next to each vehicle for sale, a guarantee acquisition fee may be displayed. This guarantee acquisition fee may indicate the additional cost, to the buyer, to purchase a no-questions-asked, money-back, vehicle-return guarantee from the auction platform. As such, if a vehicle and its respective vehicle-return guarantee are purchased, the buyer may return the vehicle to the auction platform for a full or partial refund of the vehicle purchase price.

Further, by way of example and without limitation, real-time communications between the auctioneers, buyers, and/or sellers may include auctions that are conducted based on real-time, or near real-time, exchanges of communications or data. That is, communications and/or data may be updated continuously over a period of time or any appropriate interval based on the context. For example, as those of skill in the art will understand, different contexts may create different understandings of real-time. By way of example, and not limitation, those of skill in the art understand that communications or exchanges of communications delayed by system and/or network latencies and the like may be in real-time.

As an overview, the items auctioned through the platform may be any products or services that may be sold or exchanged in an auction including, for example, and without limitation, vehicles, vehicle parts, computer products, firearms, articles of clothing, gemstones, jewelry, consumer electronics, electronics parts, yard appliances, construction machines and equipment, aircrafts, boats, office equipment, furniture, manufacturing equipment, packaging equipment, kitchen equipment, appliances, raw materials, mineral rights, water rights, combinations of the foregoing, or the like, or related products and components. While many of the embodiments of this Detailed Description are described in terms of vehicles, those of skill in the art will understand that the disclosure is not so limited, and other products, as described herein, could be substituted for vehicles.

This brief introduction, including section titles and corresponding summaries, is provided for convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

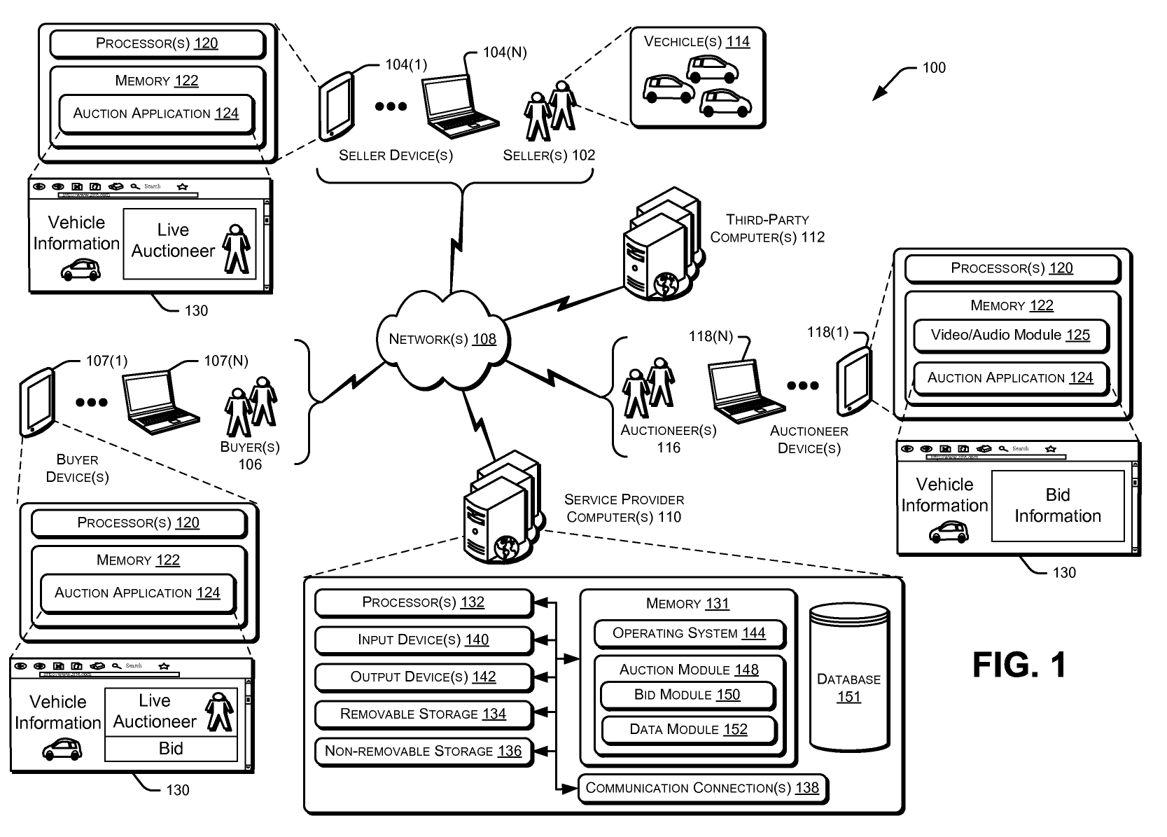

FIG. 1 depicts an illustrative system 100 in which techniques for providing live auctioneer led sales of vehicles between remotely located buyers, sellers, and auctioneers may be implemented. As shown in FIG. 1, the system 100 may include one or more service provider computers 110, one or more sellers 102 associated with one or more seller devices 104(1), . . . , 104(N), one or more buyers 106 associated with one or more buyer devices 107(1), . . . , 107(N), one or more auctioneers 116 associated with one or more auctioneer devices 118(1), . . . , 118(N), and one or more third-party computers 112. In system 100, the sellers 102 may utilize seller devices 104 to access a client application interface 130 (or website) that may be provided by, created by, or otherwise associated with one or more service provider computers 110 via one or more networks 108. In some instances, the seller devices 104 may be configured to present or otherwise display a client application interface 130 to the one or more sellers 102. The networks 108 may include any one or a combination of multiple different types of networks, such as, but not limited to, cable networks, the Internet, wireless networks, and other private and/or public networks. While the illustrated example represents the sellers 102, the buyers 106, and the auctioneers 116 accessing a client application interface 130 over the networks 108, the described techniques may equally apply in instances where the sellers 102, the buyers 106, and the auctioneers 116 interact with a service provider via a personal computer, over the phone, via a kiosk, or in any other manner. It is also noted that the described techniques may apply in other client/server arrangements (e.g., set-top boxes, etc.), as well as in non-client/server arrangements (e.g., locally stored software applications, etc.).

In some aspects, the client application interface 130 associated with the seller devices 104 may allow the sellers 102 to access, receive from, transmit to, or otherwise interact with the service provider via one or more service provider computers 110. In some examples, the client application interface 130 may also allow the sellers 102 to receive from or transmit to the service provider computers 110 over the networks 108, information associated with one or more vehicles 114 in an inventory of the seller 102 including, but not limited to, the make, the model, the color, the mileage, the vehicle identification number (VIN), the condition, the trim, the vehicle history, and/or one or more features or options, etc. Additionally, through the client application interface 130, the seller 102 may also be able to search for other vehicles that may be offered for sale by other sellers 102 associated with other seller devices 104. Further, in some examples, information about the vehicles 114 that are for sale may be provided to the service provider computers 110 by third-party providers associated with the third-party computers 112, such as, but not limited to, DMSs, other inventory management systems, other inventory data feeds, and/or one or more vehicle identification number decoders, market value databases, or the like. The third-party computers 112 may be associated with any number and/or type of third-party providers that may provide a range of information and/or services that facilitate the sale of the vehicles 114.

In certain aspects, the client application interface 130 associated with the seller devices 104 may allow the sellers 102 to monitor and/or arrange the auction of a vehicle 114. For example, the seller 102 may designate a reserve price for the vehicle 114 and/or provide an indication of a no sale of the vehicle 114 via the client application interface 130 associated with the seller devices 104. Moreover, the client application interface 130 associated with the seller devices 104 may provide the seller 102 with information associated with the auction, such as, but not limited to, information associated with a winning bid, buyer information, payment information, transportation costs, etc.

In addition, the buyers 106 may utilize buyer devices 107 to access a client application interface 130 that may be provided by, created by, or otherwise associated with one or more service provider computers 110 via one or more networks 108. In some instances, the buyer devices 107 may be configured to present or otherwise display a client application interface 130 to the one or more buyers 106. The client application interfaces 130 associated with the buyer devices 107 may allow the buyers 106 to access, receive from, transmit to, or otherwise interact with the service provider via the service provider computers 110. For example, through the client application interface 130 associated with the buyer devices 107, the buyers 106 may receive information associated with the vehicles 114 that the seller 102 would like to sell, sort and/or filter information associated with the vehicles 114, and participate in an auction for the vehicles 114. That is, the client application interfaces 130 associated with the buyer devices 107 may allow the buyers to place bids for vehicles 114 and provide the buyer 106 with information associated with the auction, such as, but not limited to, information associated with a winning bid, seller information, vehicle information, payment information, transportation costs, etc. Moreover, the client application interfaces 130 associated with the buyer devices 107 may provide the buyers with a live video signal of the auctioneer 116 auctioning the vehicles 114. In this manner, the buyers 106 may place bids for the vehicles 114 via the client application interfaces 130 associated with the buyer devices 107. In some instances, the buyers 106 may customize the client application interfaces 130. That is, the buyers 106 may be able to arrange the information presented to them via the client application interfaces 130 in any manner. For example, certain information or display features may be rearranged, resized, deleted or hidden, while other information may be made more or less prominent.

Further, a client application interface 130 may be associated with the auctioneer devices 118 and may allow the auctioneers 116 to access, receive from, transmit to, or otherwise interact with the service provider via the service provider computers 110 to participate in the auctions. For example, through the client application interface 130 associated with the auctioneer devices 118, the auctioneers 116 may lead auctions of vehicles 114 between remotely located buyers 106 and sellers 102. That is, the auctioneer 116 may take bids from the remotely located buyers 106 and otherwise conduct an auction of the vehicles 114 over the network 108 via the service provider computers 110. In some examples, the client application interface 130 associated with the auctioneer devices 118 may allow the auctioneer 116 to view information associated with the vehicles 114 up for auction, such as a make, a year, a mileage, a condition, or the like. Moreover, via the client application interface 130 associated with the auctioneer devices 118, the auctioneer 116 may view information associated with the auction, such as a run order, a start time, a current bid, a reserve price, etc.

The service provider computers 110 may be any type of computing devices, such as, but not limited to, mobile, desktop, and/or cloud computing devices, such as servers. In some examples, the service provider computers 110 may be in communication with the seller devices 104, the buyer devices 107, and the auctioneer devices 118 via the networks 108, or via other network connections. The service provider computers 110 may include one or more servers, perhaps arranged in a cluster, as a server farm, or as individual servers not associated with one another. These servers may be configured to host a website viewable via the client application interfaces 130 associated with the seller devices 104, the buyer devices 107, and the auctioneer devices 118 or any other Web browser accessible by a seller 102, a buyer 106, or an auctioneer 116, such as, but not limited to, one or more of the seller devices 104, the buyer devices 107, or the auctioneer devices 118. In addition, the service provider computers 110 may communicate with one or more applications or other programs running the seller devices 104, the buyer devices 107, or the auctioneer devices 118.

The seller devices 104, the buyer devices 107, and the auctioneer devices 118 may be any type of computing devices including, but not limited to, desktop personal computers (PCs), laptop PCs, mobile phones, smartphones, personal digital assistants (PDAs), tablet PCs, game consoles, set-top boxes, wearable computers, e-readers, web-enabled TVs, cloud-enabled devices and work stations, and the like. In certain aspects, seller devices 104, the buyer devices 107, and/or the auctioneer devices 118 may include touch screen capabilities, motion tracking capabilities, cameras, microphones, vision tracking, etc. In some instances, each seller device 104, buyer device 107, and auctioneer device 118 may be equipped with one or more processors 120 and memory 122 to store applications and data, such as an auction application 124 that may display a client application interface 130 and/or enable access to a website stored on the service provider computers 110, or elsewhere, such as a cloud computing network. In other instances, each seller device 104, buyer device 107, and auctioneer device 118 may be capable of receiving and/or transmitting one or more video signals, audio signals, and/or other signals over the network 108 and may include hardware, software, or a combination thereof to perform such functions. For example, the auctioneer devices 118 may include a video/audio module 125 that may be associated with hardware, such as a video camera or audio recorder, for capturing the auctioneer 116 as the auctioneer 116 conducts an auction of the vehicles 114.

The system 100 may also include one or more third-party services operating one or more third-party computers 112. The third-party computers 112 may also be any type of computing devices such as, but not limited to, mobile, desktop, and/or cloud computing devices, such as servers. In some examples, the third-party computers 112 may be in communication with the service provider computers 110 and/or the seller devices 104, the buyer devices 107, and/or the auctioneer devices 118 via the networks 108, or via other network connections. The third-party computers 112 may include one or more servers, perhaps arranged in a cluster, as a server farm, or as individual servers not associated with one another. These servers may be configured to provide information associated with the vehicles 114. In some aspects, the third-party services may include, but are not limited to, information aggregation services (e.g., services that determine market values for items based on aggregated information associated with those items), financial institutions, credit institutions, and the like. As such, when requested by the service provider computers 110, the third-party computers 112 may provide information associated with the vehicles 114. In some examples, this information may be utilized by the service provider computers 110 to determine a market value or other information related to the vehicles 114, which may be presented to the sellers 102, the buyers 106, and/or auctioneer 116.

In certain aspects, the service provider computers 110 may facilitate an auction for the sale of a vehicle 114. In some examples, the auctioneer 116 may take bids and/or encourage bidding from the buyers 106 in real-time over the network 108. For example, in certain embodiments, the buyers 106 and/or the sellers 102 may be provided with a real-time audio signal, a video signal, or combination thereof of a live auctioneer 116 conducting the sale of the vehicle 114 by auction. In this manner, the buyers 106 may interact with the auctioneer 116 as if they were in the same physical location. That is, the auctioneer 116 may lead (or drive) the auction by taking bids from the buyers 106, notifying the buyers 106 of current bids, encouraging bids from the buyers 106, and/or declaring a vehicle sold. Similarly, the auctioneer 116 may be provided with a real-time indication of one or more bids placed by the buyers 106 for the vehicle 114 for sale by auction.

In one illustrative configuration, the service provider computer 110 comprises at least a memory 131 and one or more processing units (or processors) 132. The processors 132 may be implemented as appropriate in hardware, software, firmware, or combinations thereof. Software or firmware implementations of the processors 132 may include computer-executable or machine-executable instructions written in any suitable programming language to perform the various functions described.

Memory 131 may store program instructions that are loadable and executable on the processors 132, as well as data generated during the execution of these programs. Depending on the configuration and type of service provider computer 110, memory 131 may be volatile (such as random access memory (RAM)) and/or non-volatile (such as read-only memory (ROM), flash memory, etc.). The service provider computer 110 or server may also include additional removable storage 134 and/or non-removable storage 136 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 131 may include multiple different types of memory, such as static random access memory (SRAM), dynamic random access memory (DRAM), or ROM.

The memory 131, the removable storage 134, and the non-removable storage 136 are all examples of computer-readable storage media. For example, computer-readable storage media may include volatile and non-volatile, removable and non-removable media implemented in any method or technology for storage of information such as computer-readable instructions, data structures, program modules, or other data. Memory 131, removable storage 134, and non-removable storage 136 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the desired information and which can be accessed by the service provider computer 110 or other computing devices. Combinations of the any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computer 110 may also contain communication connection(s) 138 that allow the service provider computer 110 to communicate with a stored database, another computing device or server, user terminals, and/or other devices on a network. The service provider computer 110 may also include input device(s) 140 such as a keyboard, mouse, pen, voice input device, touch input device, etc., and output device(s) 142, such as a display, speakers, printers, etc.

Turning to the contents of the memory 131 in more detail, the memory 131 may include an operating system 144 and one or more application programs or services for implementing the features disclosed herein, including an auction module 148. In some instances, the auction module 148 may receive, transmit, and/or store information in the database 151. In some aspects, the auction module 148 may be configured to receive and/or transmit information between the sellers 102, the buyers 106, and the auctioneers 116. For example, the auction module 148 may be configured to enable the sellers 102 to transmit and/or designate vehicles 114 to be sold at auction. In some examples, the sellers 102 may provide information associated with the vehicles 114, or the information associated with the vehicles 114 may be determined and/or received from one or more third-party computers 112, including, but is not limited to, one or more inventory management systems, market value databases, or the like.

Additionally, the auction module 148 may be configured to facilitate an auction led by a remotely located live auctioneer 116. For example, the auctioneer 116 may receive bids and/or encourage bidding from the buyers 106 and declare a vehicle 114 sold (or not sold) in real-time. In certain embodiments, the auction module 148 may be configured to provide the buyers 106 and/or the sellers 102 with a real-time audio signal, a video signal, or a combination thereof of the live auctioneer 116 conducting the sale of the vehicles 114 by auction. Similarly, the auction module 148 may be configured to provide the auctioneer 116 and/or the seller 102 with a real-time indication of one or more bids being placed by the buyers 106. In some examples, the auction module 148 may be configured to identify a winning bid for the vehicle 114 at the end of an auction.

In some instances, the auction module 148 may include one or more application programs or services for implementing the features disclosed herein, including a bid module 150 and/or a data module 152. For example, the bid module 150 may be configured to receive and/or transmit one or more bids between the auctioneer 116 and the one or more buyers 106. In some instances, the bid module 150 may be configured to provide a real-time indication of one or more bids being placed by the buyers 106 via the buyer devices 107 for the vehicles 114 for sale by auction. In some examples, the indication of a bid from the buyers 106 may include, but is not limited to, an audio signal, a video signal, an email, a text message, an instant message, a voice message, a video message, a telephone call, a video call, a combination thereof, or the like. Said signals associated with a bid may be provided to the auctioneer 116 and/or the sellers 102. In addition, the bid module 150 may be configured to provide the buyers 106 and/or the sellers 102 with a real-time audio signal, a video signal, or a combination thereof of the live auctioneer 116 conducting the sale of the vehicles 114 by auction. Accordingly, the bid module 150 may be configured to facilitate communications between the buyers 106 and the auctioneers 116 that are associated with an auction.

In certain aspects, the data module 152 may be configured to facilitate the exchange of data between the buyers 106, the sellers 102, and/or the auctioneers 116. For example, the data module 152 may be configured to receive and/or transmit information associated with the vehicles 114 to the buyers 106, the sellers 102, and/or the auctioneers 116, including, but not limited to, a vehicle identification number (VIN), a make, a model, a year, a condition, a color, a trim, a value, a mileage, an image, a recording, a video, a location, seller information, an inventory identifier, a rating, a review, an amount of time the vehicle has been in a particular inventory, or an amount of time the vehicle has been available for exchange, trade, or sale. In some instances, the data module 152 may be configured to receive the information associated with the vehicles 114 from one or more third parties associated with third party computers 112, including, but is not limited to, one or more vehicle identification number decoders, inventory management systems, dealer management systems, original equipment manufacturer databases, distributor databases, market value databases, or the like. In other instances, the data module 152 may be configured to receive the information associated with the vehicles 114 by the sellers 102 and/or by the third parties.

Various instructions, methods, and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example architectures and computing devices shown in FIG. 1 is provided by way of example only. Numerous other operating environments, system architectures, and device configurations are possible. Accordingly, embodiments of the present disclosure should not be construed as being limited to any particular operating environment, system architecture, or device configuration.

### Illustrative Processes

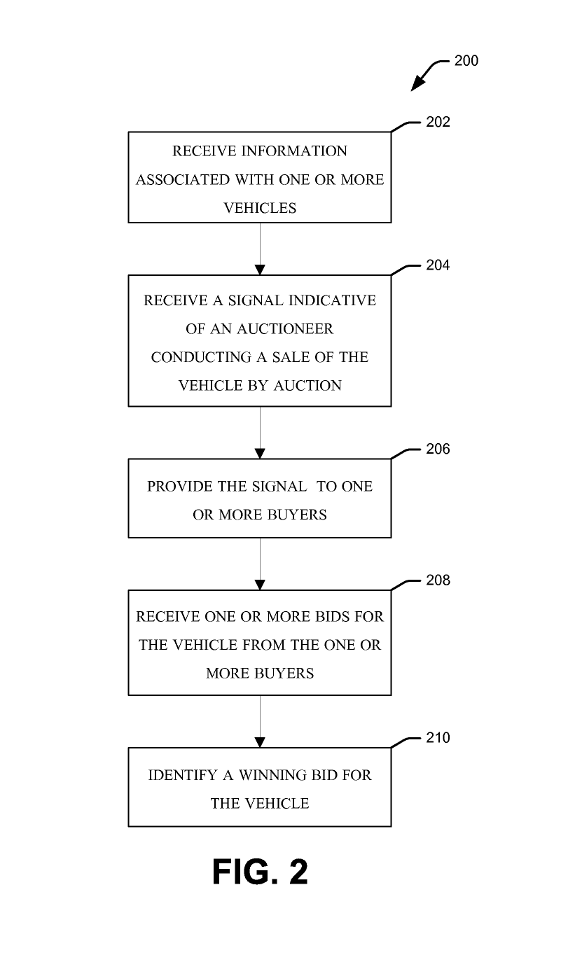

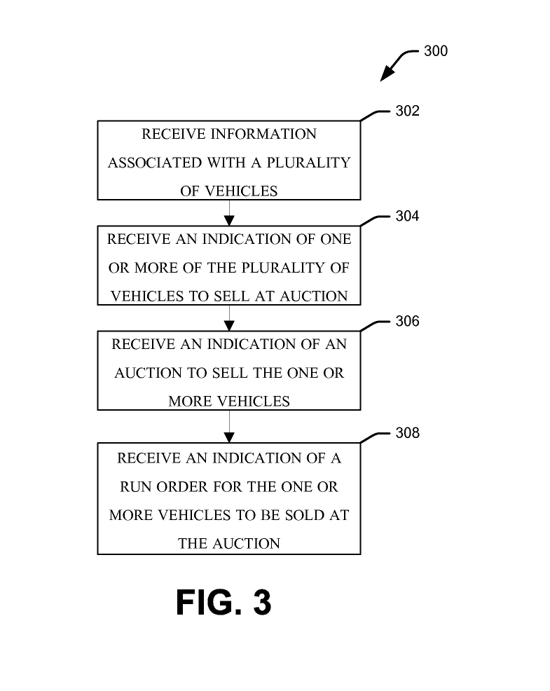

FIGS. 2 and 3 illustrate example flow diagrams showing processes 200 and 300, respectively, for providing live auctioneer led sales of vehicles between remotely located buyers, sellers, and auctioneers, as described above. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The process 200 may, but need not, be implemented by a computing device operated by a service provider, such as the service provider computers 110. In some aspects, the process 200 may begin by receiving information associated with one or more vehicles at block 202. In some examples, the sellers 102 may provide the information associated with the vehicles 114 to the service provider computers 110. In other instances, the information associated with the vehicles 114 may be determined and/or received from one or more third-party computers 112, including, but not limited to, one or more vehicle identification number decoders, inventory management systems, dealer management systems, original equipment manufacturer databases, distributor databases, market value databases, or the like. In yet other instances, the information associated with the vehicles 114 may be partially provided by the sellers 102 and/or partially provided by the third-party computers 112. The information associated with the vehicles 114 may include, but is not limited to, a vehicle identification number (VIN), a make, a model, a year, a condition, a color, a trim, a value, a mileage, a feature, an option, an image, a recording, a video, a location, seller information, an inventory identifier, a rating, a review, an amount of time the vehicle has been in a particular inventory, or an amount of time the vehicle has been available for exchange, trade, or sale. Other information may also be associated with the vehicles 114.

In certain embodiments, the information associated with the vehicles 114 may be provided to the buyers 106 before, during, or after an auction. Moreover, in some examples, the buyers 106, the sellers 102, and/or the auctioneers 116 may request additional information about the vehicles 114 from the third-party computers 112 and/or from the sellers 102.

Additionally, in some aspects, the service provider computers 110 may receive a signal indicative of an auctioneer 116 conducting a sale of the vehicle 114 by auction at block 204. For example, in certain embodiments, the signal may include a real-time audio signal, a video signal, a text-based ticker, or a combination thereof of the live auctioneer 116 conducting the sale of the vehicles 114 by auction. The process 200 may then provide the signal of the auctioneer 116 to the buyers 106 at block 206. Further, at block 208, the service provider computers 110 may receive one or more bids for the vehicles 114 from the buyers 106. For example, the buyers 106 may place the bids in real-time, or the buyers 106 may designate proxy bids (also known as absentee bids or automatic bids). That is, the buyers may designate a maximum amount they are willing to bid for a vehicle. At this stage, the process 200 may facilitate an auction led by a remotely located live auctioneer 116. For example, the sellers 102, the buyers 106, and the auctioneer 116 may all be remotely located from one another. That is, in some examples, the live auctioneer 116 may remotely take bids and/or encourage bidding from the buyers 106 in real-time. For example, as noted above, the buyers 106 and/or the sellers 102 may be provided with a real-time audio signal, a video signal, or a combination thereof of the live auctioneer 116 conducting the sale of the vehicles 114 by auction. Similarly, the auctioneer 116 may be provided with a real-time indication of the one or more bids placed by the buyers 106 for the vehicles.

The process 200 may then identify a winning bid for the vehicle 114 at block 210. For example, in some instances, the sellers 102 may designate a reserve price for the vehicle 114. In such instances, the process 200 may determine if a bid for the vehicle 114 is greater than or equal to the reserve price for the vehicle 114. Additionally, in other instances, the sellers 102 may indicate a no-sale for the vehicle 114. That is, if a vehicle for auction is not receiving many bids (if any) and the reserve price is not likely to be met, the seller 102 may have the option to designate the sale a no-sale, which may end the auction immediately. Moreover, in some examples, information associated with the winning buyer 106 may be provided to the seller 102 and information associated with the seller 102 may be provided to the winning buyer 102 at the end of the auction.

FIG. 3 illustrates a flow diagram showing the process 300 for providing live auctioneer led sales of vehicles between remotely located buyers, sellers, and auctioneers. The process 300 may, but need not, be implemented by the service provider computer 110. In some aspects, the process 300 may begin by receiving information associated with a plurality of vehicles 114 at block 302. In some aspects, the information associated with the plurality of vehicles 114 may be received via the one or more input devices 140 of FIG. 1; while in other aspects, the information associated with the plurality of vehicles 114 may be received simply via the network 108 or other means. Again, in some examples, the sellers 102 may provide the information associated with the plurality of vehicles 114 and/or the information associated with the plurality of vehicles 114 may be determined and/or received from one or more third-party computers 112 as described above.

In certain aspects, at block 304, the process 300 may then receive an indication of one or more of the plurality of vehicles 114 to sell at auction. In some instances, the sellers 102 may filter the plurality of vehicles 114 based on the information associated with the vehicles 114 (as described above) before selecting which vehicles 114 to sell. For example, the sellers 102 may filter the plurality of vehicles 114 to view a specific subset of the plurality of vehicles 114. That is, in some examples, the sellers 102 may filter the plurality of vehicles 114 based on one or more of: at least a portion of a vehicle identification number (VIN), a make, a model, a year, a condition, a color, a trim, a value, a mileage, a location, an inventory identifier, a rating, a review, an amount of time the vehicle has been in a particular inventory, an auction parameter, or an amount of time the vehicle has been available for exchange, trade, or sale, a combination thereof, or the like. As such, the sellers 102 may designate one or more vehicles 114 of the plurality of vehicles 114 (or a filtered subset thereof) to be sold at auction.

The process 300 may then receive an indication of an auction to sell the one or more vehicles 114 at block 306. That is, the sellers 102 may designate a specific auction to sell the vehicles 114. For example, several auctions may be scheduled for a day, a week, a month, or a year, etc., and the sellers 102 may specify the auctions where their vehicles will be sold. Moreover, some auctions may be based at least in part on the location of the sellers 102, the buyers 106, and/or the vehicles 114 to be auctioned. As such, the sellers 102 may select an auction that best suits their goals. Next, at block 308, the sellers 102 may designate a run order. The run order is the order the vehicles 114 are to be auctioned off at the selected auction.

Illustrative systems and methods for providing live auctioneer led sales of vehicles between remotely located buyers, sellers, and auctioneers are described above. Some or all of these systems and methods may, but need not, be implemented at least partially by architectures and/or flows such as those shown in FIGS. 1-3 above.

That which is claimed:

1. A method, comprising:
receiving, by one or more computers comprising one or more processors, information associated with one or more vehicles;
receiving, by the one or more computers, an indication of an interest to purchase at least one of the one or more vehicles from one or more buyer computing devices;
identifying, by the one or more computers and based at least in part on the interest to purchase the at least one vehicle, an auction to sell the at least one vehicle;
conducting, by the one or more computers, a live auction of the at least one vehicle, wherein the live auction comprises a signal indicative of a live auctioneer conducting a sale of the at least one vehicle by auction from an auctioneer computing device, wherein the signal comprises one or more of a real-time audio signal, a video signal, or a combination thereof of the live auctioneer conducting the sale of one of the at least one vehicle by auction;
providing, by the one or more computers, the signal indicative of the live auctioneer conducting the sale of one of the at least one vehicle by auction to the one or more buyer computing devices, wherein at least one of the auctioneer computing device, the one or more buyer computing devices, and the at least one vehicle are geographically remotely located from one another; and
receiving, by the one or more computers, one or more bids for the at least one vehicles from the one or more buyer computing devices.

2. The method of claim 1, further comprising providing, by the one or more computers, the information associated with the vehicle to the one or more buyer computing devices.

3. The method of claim 1, further comprising identifying, by the one or more computers and based at least in part on the one or more bids for the vehicle from the one or more buyer computing devices, a winning bid for the vehicle.

4. The method of claim 1, further comprising providing, by the one or more computers, the one or more bids for the vehicle from the one or more buyer computing devices to the auctioneer computing device.

5. The method of claim 1, further comprising providing, by the one or more computers, the signal indicative of the live auctioneer conducting the sale of the vehicle by auction to a seller computing device.

6. The method of claim 1, further comprising receiving, by the one or more computers, the information associated with the vehicle from one or more third-party computing devices.

7. The method of claim 1, further comprising providing, by the one or more computers, a listing of one or more vehicles to be sold by auction to the one or more buyer computing devices.

8. The method of claim 1, further comprising:
receiving, by the one or more computers, market value information associated with the vehicle from a market value database; and
providing, by the one or more computers, the market value information associated with the vehicle to the one or more buyer computing devices.

9. The method of claim 1, further comprising providing, by the one or more computers, an interface to the one or more buyer computing devices that facilitates sending, to a seller computing device, an email, a text message, an instant message, a voice message, a video message, a telephone call, or a video call.

10. A method, comprising:
receiving, by one or more computers comprising one or more processors, information associated with one or more vehicles;
receiving, by the one or more computers, an indication of an interest to purchase at least one of the one or more vehicles from one or more buyer computing devices;
placing, by the one or more computers and based at least in part on the interest to purchase the at least one vehicle, the at least one vehicle in an auction;
receiving, by the one or more computers, one or more bids for the at least one vehicles from the one or more buyer computing devices.
